(19) United States
(12) Patent Application Publication
(10) Pub. No.: US 2015/0134344 A1
(43) Pub. Date: May 14, 2015

(54) Personal Health Data Gathering for Incentive and Insurance Rating Purposes

(71) Applicant: STATE FARM MUTUAL AUTOMOBILE INSURANCE COMPANY, Bloomington, IL (US)

(72) Inventors: David Turrentine, Bloomington, IL (US); Jeremy Myers, Normal, IL (US); Abby Tohline, Bloomington, IL (US); Angi Bobsin, Heyworth, IL (US); Kelly S. Minter, Normal, IL (US); Larry J. Ingrum, Mahomet, IL (US)

(73) Assignee: STATE FARM MUTUAL AUTOMOBILE INSURANCE COMPANY, Bloomington, IL (US)

(21) Appl. No.: 14/078,793

(22) Filed: Nov. 13, 2013

(51) Int. Cl. G06F 19/00

(52) U.S. Cl. CPC G06F 19/328; G06F 19/3406
USPC 705/2

(57) ABSTRACT

An insurance method and computer system provides incentives and insurance ratings to a policy holder. The policy holder may opt to participate in an incentives program in which the method and system may receive baseline personal health data that indicates a baseline health condition and a target goal to improve or maintain that baseline health condition over a specified time period. The method and system may then receive and analyze personal health data generated by a sensor that monitors a current health condition over the specified time period to determine whether the target goal has been achieved. The method and system may provide an indication of an incentive to the policy holder in response to receiving the personal health data generated by the sensor, and may provide an indication of a further incentive in response to determining that the target goal has been met.

### TECHNICAL FIELD

The present application relates generally to insurance and, more specifically, to systems and methods for collecting and processing personal health data for incentive and insurance rating purposes.

### BACKGROUND

In insurance industries, such as property/casualty, liability, life, health, and long-term care insurance industries, insurance providers generally seek to determine an insurance policy premium that is appropriate given the risk of losses (e.g., property theft, health issues requiring medical treatment, death, etc.) for an individual owning the policy. For purposes of making this determination, it is well understood that behaviors of the individual can exert a great influence on the probability that the individual experiences a loss that is recognizable under the policy. For example, an individual who smokes cigarettes on a regular basis is much more likely to incur large medical bills as compared to a non-smoker. In some circumstances, behaviors such as this must be learned based on information provided by the insurance policy holder, or future insurance policy holder, in response to questions from the insurer (e.g., questions regarding how much the individual smokes cigarettes, drinks alcoholic beverages, etc.).

Generally, individuals demonstrating behaviors corresponding to a lower risk of loss (“low-loss behaviors”) may be assigned a more positive insurance rating, and may therefore be offered lower insurance premiums for a given level of coverage. Conversely, individuals demonstrating behaviors corresponding to a higher risk of loss (“high-loss behaviors”) may be assigned a more negative insurance rating, and may therefore be offered higher insurance premiums for the same level of coverage. Additionally, individuals demonstrating high-loss behaviors may be offered incentives or rewards to motivate them to change their behaviors from being high-risk to low-risk. Similarly, individuals demonstrating low-loss behaviors may also be offered incentives to encourage them to keep demonstrating continued or further low-loss behaviors.

Unfortunately, insurers generally have access to a very limited amount of information with respect to policy holder behaviors. Questionnaires provided by insurers to prospective policy holders are typically very limited in scope, as insurers may only be aware of a small subset of the universe of behaviors affecting the risk of loss. Moreover, responses to insurer questionnaires may in some cases be inaccurate. For example, a prospective policy holder may not know the precise number of alcoholic beverages, on average, that he or she imbibes per week.

For life, health and long-term care insurers, insurance ratings are usually based on existing health vitals (e.g., heart rate, blood pressure, urinary output, etc.) plus medical factors collected during a medical exam. However, other behaviors that may substantially affect the likelihood of some types of losses are generally not included or not well characterized. For example, companies providing life/health insurance may be unaware of a policy holder's various behaviors affecting the risk of losses such as how often or how long the policy holder exercises, and/or may find it difficult to determine whether the policy holder exhibits those behaviors. As a result, insurance ratings determined for the policy holder may be poorly correlated to the policy holder's actual risk of loss.

### SUMMARY

The features and advantages described in this summary and the following detailed description are not all-inclusive. Many additional features and advantages will be apparent to one of ordinary skill in the art in view of the drawings, specification, and claims hereof. Additionally, other embodiments may omit one or more (or all) of the features and advantages described in this summary.

A computer-implemented method of encouraging low-loss personal health behaviors may include determining, via a computer, if an individual insurance policy holder has opted to participate in an incentives program. In response to determining that the individual insurance policy holder has opted to participate in the incentives program, the method may receive via a computer, baseline personal health data that indicates a baseline personal health condition of the individual insurance policy holder. The method may also receive via a computer, a target goal set by the individual insurance policy holder to improve or maintain the baseline personal health condition of the individual insurance policy holder over a specified time period. Further, the method may receive via a computer, personal health data generated by a sensor that monitors a current personal health condition of the individual insurance policy holder over the specified time period. In response to receiving the personal health data generated by the sensor, the method may provide via a computer, an indication of an incentive to the individual insurance policy holder. The method may then determine via a computer, if the target goal has been achieved by analyzing the received personal health data and baseline personal health data to determine whether the baseline personal health condition of the individual insurance policy holder has been improved or maintained by the current personal health condition of the individual insurance policy holder over the specified time period. In response to determining that the target goal has been achieved, the method may provide via a computer, an indication of a further incentive to the individual insurance policy holder.

A non-transitory computer-readable storage medium may comprise computer-readable instructions to be executed on one or more processors of a system for encouraging low-loss personal health behaviors. The instructions when executed, may cause the one or more processors to determine if an individual insurance policy holder has opted to participate in an incentives program. In response to determining that the individual insurance policy holder has opted to participate in the incentives program, the instructions when executed, may cause the one or more processors to receive baseline personal health data that indicates a baseline personal health condition of the individual insurance policy holder. The instructions when executed, may also cause the one or more processors to receive a target goal set by the individual insurance policy holder to improve or maintain the baseline personal health condition of the individual insurance policy holder over a specified time period. Further, the instructions when executed, may cause the one or more processors to receive personal health data generated by a sensor that monitors a current personal health condition of the individual insurance policy holder over the specified time period. In response to receiving the personal health data generated by the sensor, the instructions when executed, may cause the one or more processors to provide an indication of an incentive to the individual insurance policy holder. The instructions when executed, may then cause the one or more processors to determine if the target goal has been achieved by analyzing the received personal health data and baseline personal health data to determine whether the baseline personal health condition of the individual insurance policy holder has been improved or maintained by the current personal health condition of the individual insurance policy holder over the specified time period. In response to determining that the target goal has been achieved, the instructions when executed, may cause the one or more processors to provide an indication of a further incentive to the individual insurance policy holder.

A computer system for encouraging low-loss personal health behaviors may comprise a personal health data repository and an insurance server that includes a memory having instructions for execution on one or more processors. The instructions when executed by the one or more processors, may cause the insurance server to determine if an individual insurance policy holder has opted to participate in an incentives program. In response to determining that the individual insurance policy holder has opted to participate in the incentives program, the instructions when executed by the one or more processors, may receive via a network connection, baseline personal health data that indicates a baseline personal health condition of the individual insurance policy holder and store the received baseline personal health data in the personal health data repository. The instructions when executed by the one or more processors, may also receive via a network connection, a target goal set by the individual insurance policy holder to improve or maintain the baseline personal health condition of the individual insurance policy holder over a specified time period. Further, the instructions when executed by the one or more processors, may receive via a network connection, personal health data generated by a sensor that monitors a current personal health condition of the individual insurance policy holder over the specified time period and store the received personal health data in the personal health data repository. In response to receiving the personal health data generated by the sensor, the instructions when executed by the one or more processors, may provide via a network connection, an indication of an incentive to the individual insurance policy holder. The instructions when executed by the one or more processors, may then determine if the target goal has been achieved by analyzing the received personal health data and baseline personal health data in the personal health data repository to determine whether the baseline personal health condition of the individual insurance policy holder has been improved or maintained by the current personal health condition of the individual insurance policy holder over the specified time period. In response to determining that the target goal has been achieved, the instructions when executed by the one or more processors, may provide via a network connection, an indication of a further incentive to the individual insurance policy holder via the network connection.

### BRIEF DESCRIPTION OF THE DRAWINGS

FIG. 1 is a block diagram of an example insurance system for providing incentives and insurance ratings based on personal health data.

FIG. 2 is a flow diagram of an example method for providing incentives and encouraging low-loss behaviors for a policy holder.

FIG. 3 is a flow diagram of an example method for providing insurance ratings and encouraging low-loss behaviors for a policy holder.

FIG. 4 is a block diagram of a computing environment that implements a system and method for providing incentives and insurance ratings based on personal health data.

The figures depict a preferred embodiment of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

A growing number of people are becoming interested in managing their own health, and monitoring data that reflects their health status using self-monitoring health technology. Generally speaking, the disclosed system collects and analyzes data (generally referred to herein as “personal health data”) associated with a current or potential insurance policy holder in order to provide the policy holder with incentives and insurance ratings. The personal health data is generated or based on information generated by various self-monitoring health sensors or devices, and may be indicative of personal health or wellness conditions of the policy holder.

The policy holder may participate in an incentives program in which the policy holder defines a goal that will improve or maintain a health or wellness condition of the policy holder and then works toward achieving that goal. For example, to stay healthy, the policy holder may establish a goal to achieve a certain body mass index (BMI) value through exercise and diet. The personal health data associated with the policy holder is collected and analyzed over a specified period of time to determine if the policy holder has achieved the stated goal. If the goal is achieved, then incentives are offered to the policy holder. The incentives may be in the form of monetary rewards, for example. Moreover, as an initial encouragement, initial incentives may be offered to the policy holder as soon as the policy holder begins supplying his or her personal health data.

Alternatively or additionally, the personal health data associated with the policy holder may be collected and analyzed to determine whether the personal health data is indicative of personal health or wellness conditions that are known to raise or lower the risk of a recognizable loss. For example, if it is known that good sleeping habits statistically correlate to a lower risk of loss (e.g., staying healthy), then data generated by a sleep pattern monitoring device that the policy holder is using may be analyzed to determine whether any of those sleeping habits exist. If the data is determined to correspond to good sleeping habits, then the policy holder's insurance premium may be adjusted or lowered accordingly.

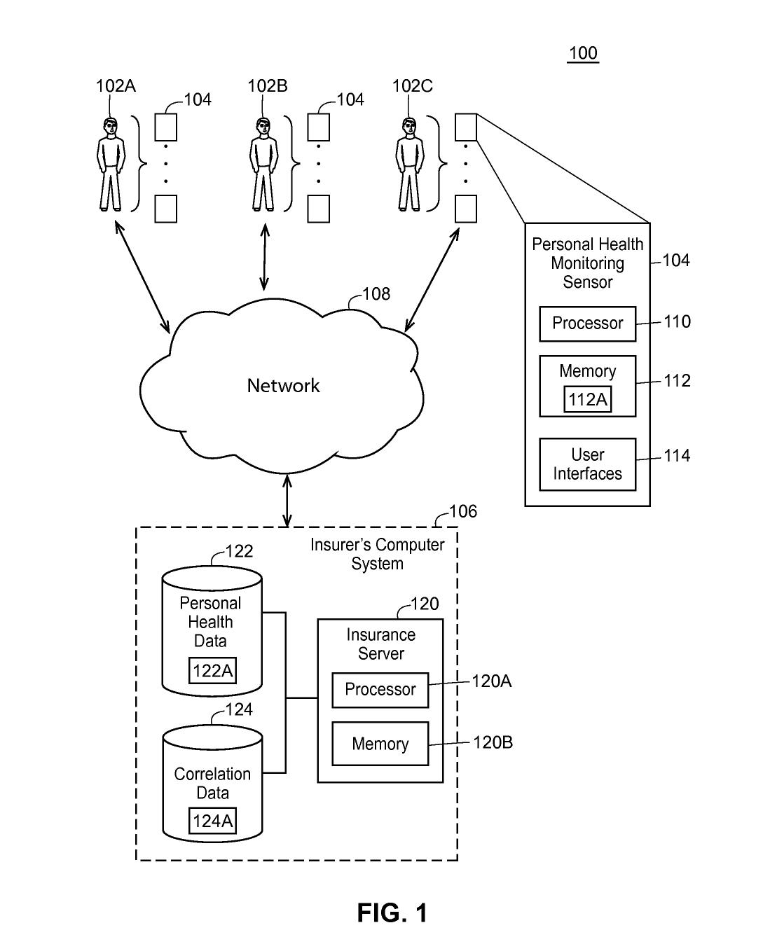

FIG. 1 is a block diagram of an example insurance system 100 for providing incentives and insurance ratings based on personal health data. The example insurance system 100 includes a plurality of individual policy holders 102A-102C, each having one or more personal health monitoring sensors or devices 104 that are communicatively coupled to an insurer's computer system 106 via a network 108 (e.g., a local area network, a wide area network, a mobile network, a wired or wireless network, a private network, etc.). The particular type(s) and number of sensors for each of the policy holders 102A-102C may be identical, or may vary from one policy holder to the next. Further, while only three policy holders 102A-102C are shown in FIG. 1, the insurance system 100 may include more or fewer policy holders in other embodiments and/or scenarios.

In the embodiment shown in FIG. 1, each of the personal health monitoring sensors 104 includes a processor 110, a memory 112, and user interfaces 114 (e.g., a display screen, a touchscreen, a keyboard, an analog control panel, etc.). A human operator (e.g., one of the policy holders 102A-102C) may enter inputs to operate the personal health monitoring sensors 104 (e.g., setting sensor parameters, storing and displaying data, etc.) via the user interfaces 114. Additionally or alternatively, the operator may control the personal health monitoring sensors 104 by entering inputs in a computing device (e.g., a smart phone, a tablet computer, a personal computer, etc., not shown in FIG. 1) connected to the personal health monitoring sensors 104 either directly or remotely via the network 108.

Generally speaking, the personal health monitoring sensors 104 may include any existing or future devices capable of detecting, collecting, storing, transmitting, and/or displaying data related to the personal health of a policy holder, and may, for example, be wearable, implantable, ingestible, hand-held, or placed off the body.

As an example, the personal health monitoring sensors 104 may be heart rate monitors, pulse oximeters, blood pressure monitors, sleep pattern monitors, etc., used to measure various physiological parameters of the policy holders 102A-102C (e.g., heart rate, blood pressure, sleep patterns, etc.).

As another example, the personal health monitoring sensors 104 may be pedometers, smart watches, electronic fitness bracelets, mobile phones with motion sensors, etc., used to measure various fitness activities carried out by the policy holders 102A-102C such as walking, running, biking, swimming or weight training. Devices that measure fitness activities may also include electronic devices attached to exercise or recreational equipment such as a bike.

As yet another example, the personal health monitoring sensors 104 may be medical devices such as blood biometric analyzers (e.g., a blood glucose meter) used to measure biometric marker levels in the blood such as cholesterol levels, blood glucose levels, nutrient levels, etc., or electromyography devices used to measure electrical activities in the muscles to analyze biomechanics.

As a further example, the personal health monitoring sensors 104 may be medication monitoring devices (e.g., smart pills) used to measure medication usage by the policy holders 102A-102C (e.g., correct intake of medicine, failure to intake medicine, refills, etc.). Additional examples of the personal health monitoring sensors 104 may include temperature sensors, humidity sensors, etc., used to measure other factors such as environmental factors that may affect the health or wellness condition of the policy holders 102A-102C.

Data gathered by the personal health monitoring sensors 104 may be stored in the memory 112 as personal health data 112A before being transmitted to the insurer's computer system 106 via the network 108. In some embodiments, data gathered by the personal health monitoring sensors 104 may be transmitted directly to the insurer's computer system 106 via the network 108.

The personal health monitoring sensors 104 may only collect and send the personal health data 112A with a policy holder's full understanding and acceptance of published terms and conditions for collection and use of that data. For example, before the personal health monitoring sensors 104 execute instructions to collect or process this data, a visual or other prompt at the personal health monitoring sensors 104 may alert the policy holder to such action. The prompt allows the policy holder to “opt out” of some or all collection of the personal health data 112A, or any other types of data as described herein.

In some embodiments, some or all of the personal health data 112A gathered by the personal health monitoring sensors 104 may be sent to the insurer's computer system 106 via a third party. For example, a server of a personal health monitoring system provider (not shown in FIG. 1) may store the personal health data 112A collected by the sensors 104 and send the data 112A to the insurer's computer system 106 via the network 108 or a different network.

With continued reference to FIG. 1, the insurer's computer system 106 includes an insurance server 120, which may be a single server or a plurality of servers with distributed processing, a personal health data repository 122, and a correlation data repository 124. The insurance server 120 may, at a policy holder's (e.g., one of the policy holders 102A-102C) option and understanding, receive the personal health data 112A stored in the memory 112 via the network 108. The received personal health data is stored in the personal health data repository 122 as personal health data 122A. The insurance server 120 may operate directly on the personal health data 122A provided in the personal health data repository 122, or may operate on other data that is generated based on the personal health data 122A from personal health data repository 122. For example, the insurance server 120 may convert the data 122A in the repository 122 to a particular format (e.g., for efficient storage), and later utilize the modified data for incentive and insurance rating purposes.

A processor 120A of the insurance server 120 may execute instructions stored in a memory 120B of the insurance server 120 to retrieve data stored in the personal health data repository 122 and the correlation data repository 124. In some embodiments, the data repository 122 and/or the data repository 124 is/are instead located outside of the insurer's computer system 106, and is/are accessible by the insurance server 120 via a network such as the network 108.

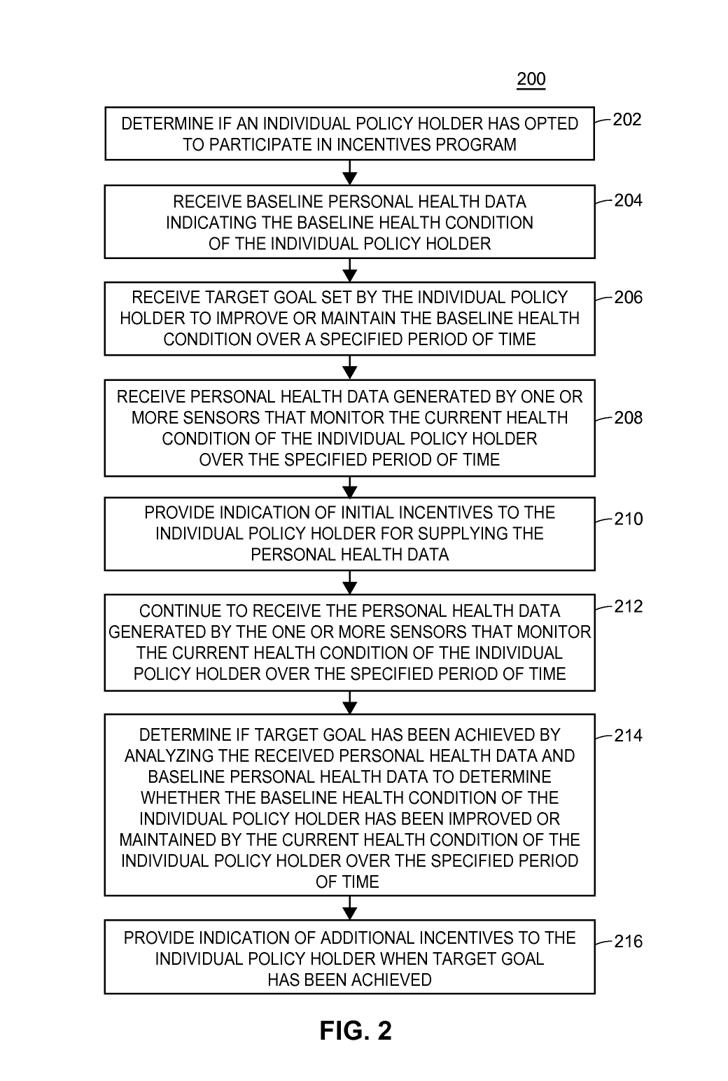

The insurance server 120 may be configured to provide incentives to a policy holder (e.g., one of the policy holders 102A-102C) through an incentives program in order to encourage and reward low-loss behaviors. Providing incentives to the policy holder is described in more detail below in connection with FIG. 2.

Alternatively or additionally, the insurance server 120 may be configured to provide insurance ratings to the policy holder. To do so, the insurance server 120 uses data stored in the correlation data repository 124, which may include one or more data correlation models 124A, to determine data correlations between (a) usage patterns of the personal health monitoring sensors 104, and/or patterns relating to personal health or wellness conditions monitored by the sensors 104, and (b) chances of incurring recognizable losses under a policy holder's policy. The insurance server 120 may analyze data (e.g., the data 122A) stored in the personal health data repository 122 using one or more of the data correlation models 124A in order to determine a risk rating, or a parameter corresponding to a risk rating (e.g., a change in an insurance premium). Some example embodiments and scenarios are described here for illustration purposes.

In one example embodiment, an active lifestyle data correlation model (e.g., stored as one of the data correlation models 124A) in the correlation data repository 124 may be used. For example, the insurance server 120 may compare the number of steps that a policy holder has walked in a given day as determined based on data received from a pedometer that the policy holder is using and stored in the personal health data repository 122 as the data 122A. The active lifestyle data correlation model may identify one or more ranges of steps (e.g., 0-2000 steps, 2001-4000 steps, etc.), and determine a risk indicator that the active lifestyle data correlation model indicates as being associated with the range that matches the data 122A. To this end, each step range may correspond to an indicator of loss likelihood. The insurance server 120 may then determine an insurance premium adjustment that corresponds to the identified risk indicator, such as a discount (e.g., 5%, 10%, etc.) if the policy holder is identified to lead an active lifestyle.

In another example embodiment, the data 122A in the personal health data repository 122 may include data collected while monitoring a policy holder's sleep pattern over time as received from a sleep monitoring device that the policy holder is using. A sleep pattern data correlation model (e.g., stored as one of the data correlation models 124A) in the correlation data repository 124 may indicate that a lack of sleep or a persistently low level of sleep over time corresponds to a poor state of health that can lead to a high-risk of loss. Thus, by comparing the data 122A to the sleep pattern data correlation model, the insurance server 120 may determine an appropriate risk of loss and/or insurance premium adjustment.

In still another example embodiment, the data 122A in the personal health data repository 122 may include data indicating a policy holder's household temperature as received from a temperature sensor in the policy holder's home. An indoor temperature data correlation model (e.g., stored as one of the data correlation models 124A) in the correlation data repository 124 may indicate that lower temperatures at the policy holder's home may negatively affect the health of the policy holder, which can lead to a high-risk of loss. For example, cold houses can lead to dampness, which in turn can increase the risk of respiratory illnesses. As well, dampness can lead to mold growth, which contributes to respiratory problems. Thus, the insurance server 120 may analyze the data 122A to determine a risk of loss and/or insurance premium adjustment according to the indoor temperature data correlation model.

It is understood that the above examples are not exclusive, and that more than one such embodiment may coexist within a single insurance system.

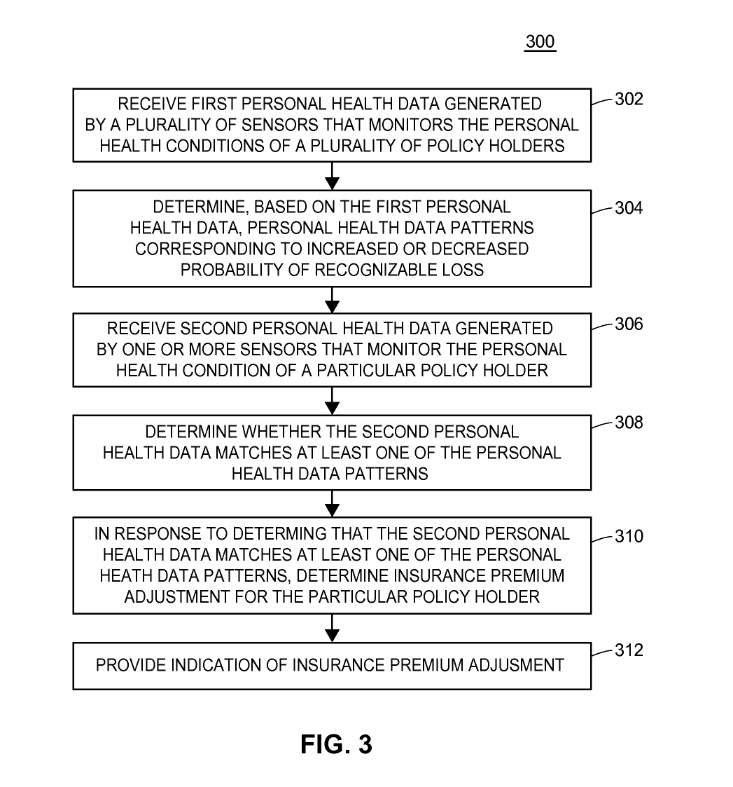

In some embodiments, the correlation data repository 124 may include more complex models or algorithms that depend on multiple types of data, generated by multiple sensors, in order to determine a risk of loss. Generally speaking, data stored in the correlation data repository 124 may be based on manually entered information, or may be “learned” by the insurance server 120 (or another server not shown in FIG. 1) based on data collected from a plurality of policy holders, as described in more detail below in connection with FIG. 3.

Referring now to FIG. 2, which describes a flow diagram of an example method 200 for providing incentives and encouraging low-loss behaviors. The method 200 may include one or more blocks, routines or functions in the form of computer executable instructions that are stored in a tangible computer-readable medium (e.g., 120B of FIG. 1) and executed using a processor (e.g., 120A of FIG. 1). Generally speaking, the method 200 relates to an incentives program or plan that offers incentives or rewards to participants when the participants demonstrate low-loss behaviors (e.g., staying healthy, improvements in health or wellness, reduced health risks, etc.).

The method 200 begins by determining that an individual policy holder (e.g., one of the policy holders 102A-102C of FIG. 1) has opted to participate in an incentives program (block 202). For example, the method 200 may receive an indication from the individual policy holder at the block 202 that indicates the individual policy holder has opted to participate in the incentives program.

Next, the method 200 receives baseline personal health data from the participating policy holder (block 204). The baseline personal health data may be based on existing or available information, or may be generated by, for example, sensors (e.g., the personal health monitoring sensors 104 of FIG. 1) that are being used or being associated with the participating policy holder. The baseline personal health data may be data indicating a baseline health or wellness condition of the participating policy holder. For example, the baseline health or wellness condition of the policy holder may include the policy holder's existing BMI, cholesterol level, weight, etc., or any combination thereof.

The method 200 then receives a target goal set by the participating policy holder (block 206). The target goal may specify improving or maintaining the baseline health condition of the participating policy holder. For example, the policy holder may establish a goal to improve or maintain his or her BMI to within a certain percentage. Alternatively or additionally, the target goal may specify lowering or reducing a risk associated with the baseline health condition. For example, if the baseline health data indicates that the policy holder is at risk of developing diabetes, then the policy holder may set a goal to reduce the risk of diabetes through a healthier diet. Further, the target goal may specify activities, such as fitness activities, associated with improving or maintaining the baseline health condition. For example, the policy holder may define a goal of walking 10,000 steps per day in order to maintain a certain BMI value. The target goal may be defined to be achieved over a specified period of time (e.g., a month, a year, etc.). In some embodiments, different milestones may be established within the specified time period to gauge the progress of achieving the target goal. The milestones may be defined as intermediate goals that can be achieved on the way to achieving the final target goal.

Once the target goal is set, the method 200 receives personal health data from one or more sensors (e.g., the personal health monitoring sensors 104 of FIG. 1) used by or associated with the participating policy holder (block 208). The data generated may be indicative of a current health or wellness condition monitored by the sensors (e.g., data from a weight scale indicating the policy holder's weight), and/or may be indicative of a utilization of the sensors (e.g., data from a pedometer indicating the number of steps walked per day by the policy holder). The current health or wellness condition of the policy holder may include the policy holder's most up-to-date BMI, cholesterol level, weight, etc., or any combination thereof, for example. The personal health data is received via a communication network, such as the network 108 of FIG. 1.

As an initial encouragement to the participating policy holder, the method 200 may provide an indication of initial incentives as soon as the policy holder begins supplying or sharing the personal health data (block 210). For example, the method 200 may determine to reward the participating policy holder with money (or an indication of money), with goods or services (or an indication of goods or services) that the policy holder desires, or with a mixture of both.

After providing the initial incentives, the method 200 continues to receive the personal health data generated by the one or more sensors (block 212). The personal health data may be received continuously or periodically over the specified time period. In some embodiments, the personal health data is automatically received via the communication network without any need for human involvement (e.g., entering requests for the information). Moreover, the personal health data may be sent without any prompting, or may be sent in response to several requests (e.g., from a server similar to insurance server 120 of FIG. 1). Further, in some embodiments, at least a portion of the personal health data is received via a third party (e.g., from a personal heath monitoring system provider that initially collects data from the participating policy holder). The received personal health data may be stored in a database, such as the personal health data repository 122 of FIG. 1.

Next, the method 200 determines if the participating policy holder has achieved the target goal over the specified time period (block 214). The method 200 may analyze the personal health data received at the block 212 with the baseline personal health data received at the block 204 to determine whether the baseline health condition of the participating policy holder has been improved or maintained by the current health condition of the participating policy holder over the specified time period. For example, if the baseline personal health data received at the block 204 indicated that the policy holder was overweight and the target goal set by the policy holder was to lose a certain amount of weight within a year, then at the end of the year, the method 200 may assess the target goal by comparing the personal health data received at the block 212 with the baseline personal health data to determine if the certain amount of weight was lost.

In some embodiments, the method 200 may compare the personal health data received at the block 212 with the baseline personal health data to determine whether a certain risk associated with the baseline health condition of the participating policy holder has been reduced if the target goal was set to reduce the certain risk.

In other embodiments, the method 200 may analyze the personal health data received at the block 212 with the baseline personal health data on a periodic basis. For example, if the target goal specifies that an exercise activity needs to be completed weekly in order to maintain a certain baseline health condition of the policy holder, then the method 200 may assess the target goal each week by determining whether the policy holder has completed the required exercise activity.

In further embodiments, milestones may be established at regular intervals during the specified time period of the target goal. In this scenario, at each interval, the method 200 may compare the personal health data received at the block 212 against the established milestones to evaluate the overall progress of achieving the target goal. The method 200 may determine that the target goal has been achieved when conditions in each of the milestones have been satisfied or if conditions in a certain number of milestones have been satisfied.

When the method 200 determines that the target goal has been successfully reached, the method 200 may provide an indication of additional incentives to the participating policy holder (block 216). For example, the method 200 may determine to reward the participating policy holder with money (or an indication of money), with goods or services (or an indication of goods or services) that the participating policy holder desires, or with a mixture of both. In some embodiments, for target goals that specify a reduction in a risk associated with the baseline health condition of the policy holder, the additional incentives may include an adjustment (or an indication of an adjustment) of the participating policy holder's insurance premium. In other embodiments, the additional incentives may be provided at the completion of each milestone established in the target goal.

The blocks 202 to 216 may be repeated multiple times. For example, the policy holder may participate in the incentives program on a regular basis (e.g., at various times throughout year, during each month, etc.), and receive incentives for achieving a target goal (or for completing milestones established in the target goal) that improves or maintains his or her existing health status.

FIG. 3 is a flow diagram of an example method 300 for providing insurance ratings and encouraging low-loss behaviors. The method 300 may include one or more blocks, routines or functions in the form of computer executable instructions that are stored in a tangible computer-readable medium (e.g., 120B of FIG. 1) and executed using a processor (e.g., 120A of FIG. 1).

Generally speaking, the method 300 relates to a process of collecting personal health data from multiple policy holders and using the collected data to determine data correlations between (a) recognizable losses and (b) health or wellness conditions. Based on the determined data correlations, the method 300 collects and analyzes personal health data from a particular (current or potential) policy holder to determine and indicate an insurance premium adjustment for the particular policy holder. For example, referring to FIG. 1, a policy holder for which an insurance rating is being determined is also one of the policy holders 102A-102C. Thus, a first set of personal health data from the policy holders 102A-102C may be initially used to determine data correlation models (e.g. the data correlation models 124A of FIG. 1), and a later, second set of personal health data from the same policy holder may then be used along with the data correlation models to determine an insurance rating for the policy holder.

The method 300 receives first personal health data from a plurality of policy holders (e.g., the policy holders 102A-102C of FIG. 1). The first personal health data may be generated by, or based on information generated by, a plurality of sensors (e.g., the personal health monitoring sensors 104 of FIG. 1) being used or being associated with the plurality of policy holders (block 302). The first personal health data may include data indicative of health or wellness conditions monitored by some or all of the plurality of sensors, and/or data indicative of utilizations of some or all of the plurality of sensors. The plurality of policy holders may be current policy holders, potential policy holders, or a mix of both.

The first personal health data is received via one or more communication networks, such as the network 108 of FIG. 1. In some embodiments, the first personal health data is automatically received via the network(s) without any need for human involvement (e.g., entering requests for the information). Further, in some embodiments, at least a portion of the first personal health data may be received via a third party (e.g., from a personal heath monitoring system provider that initially collects data from the plurality of policy holders).

The method 300 then determines, based on information in the block 302, one or more personal health data patterns corresponding to an increased or decreased probability of recognizable loss (block 304). The personal health data patterns may represent patterns of sensor usage, and/or patterns of sensed/monitored health or wellness conditions, that can be matched to loss probabilities, and incorporated in a correlation model. For example, the method 300 may determine ranges of sensor output values that correspond to loss probabilities, scheduling/timing patterns that correspond to loss probabilities, etc. The correlation models determined by the method 300 may be stored in a database such as the correlation data repository 124 of FIG. 1.

Next, the method 300 receives second personal health data generated by, or based on information generated by, one or more sensors used by or associated with a particular policy holder (block 306). The particular policy holder may be a current or potential insurance policy holder, for example. While the first personal health data received at the block 302 is used to determine the personal health data patterns corresponding to various probabilities of losses, the second personal health data is used to assess the risk of loss associated with the particular policy holder.

The method 300 determines, based on information in the blocks 304 and 306, whether the second personal health data matches at least one of the determined personal health data patterns (block 308). To this end, the second personal health data may be processed utilizing a correlation model generated based on the determined personal health data patterns. For example, in an embodiment in which the method 300 determines (at block 304) that one or more ranges of sensor output values correspond to an increased or decreased probability of incurring a recognizable loss, the method 300 may determine whether the second personal health data falls within at least one of those ranges of the sensor output values. In other embodiments, the personal health data patterns are more complex, and determining whether the second personal health data matches any of the patterns involves more than simply determining if a range within which a sensor output value falls. For example, the personal health data pattern(s) may reflect multiple parameters (e.g., state of a sensor or sensed condition, time of the state or condition, etc.), and/or the personal health data pattern(s) may be matched only by satisfying a non-trivial algorithm (e.g., only if a certain state or condition exists at certain times of day, or with a certain frequency, etc.).

The method 300 in response to determining at the block 308 that the second personal health data matches at least one of the personal health data patterns, determines an insurance premium adjustment (e.g., a premium adjustment that corresponds to the matched personal health data pattern(s)) for the particular policy holder (block 310). For example, the premium may be a monthly, quarterly, or annual premium, and the premium may be for life, health, long-term care, or another type of insurance. In some embodiments, the adjustment can be either a premium discount or “no change,” depending on the personal health data. In other embodiments, the adjustment can be either a discount or a premium penalty/increase. Generally speaking, the premium adjustment may be determined for an existing policy (if for a current policy holder), or to include in a quote (if for a potential policy holder).

Alternatively, in some embodiments, the method 300 may determine the insurance premium adjustment at least in part by monitoring the second personal health data received from the particular policy holder to determine either a positive (or low-loss) behavior (e.g., active lifestyle, good sleeping habits, proper nutritional diet, etc.), or a negative (or high-loss) behavior (e.g., lack of physical exercise, overeating, insufficient sleep, etc.) of the particular policy holder. The method 300 may then calculate the insurance premium adjustment based on the determined positive or negative behavior. Other alternative embodiments include determining the insurance premium adjustment based on algorithms that analyze how behaviors affect risk, or based on an analysis of claims data without analyzing any corresponding personal health data. For example, one might be justified in assuming that losses (e.g., poor state of health) are more likely when an individual never exercises, and a review of past claims may indicate that losses are much more likely to occur when the individual fails to exercise on a regularly basis.

The method 300 proceeds to provide an indication of the insurance premium adjustment (block 312). For example, the method 300 may provide the indication by displaying information to an operator of an insurer's computer system (e.g., the insurer's computer system 106 of FIG. 1), data provided to a software module within the insurer's computer system (e.g., a software module that accepts various premium adjustments resulting from various determinations, and calculates a total premium), or a printable statement file which can be delivered to the particular policy holder as an account statement or to another individual (e.g., a potential policy holder) as a quote. The account statement or quote may show the adjustment to the premium, and/or the total premium including the adjustment.

The blocks 302 and 304, and/or the blocks 306 to 312, may be repeated multiple times. For example, additional personal health data associated with the plurality of policy holders may be received on a substantially continuous basis (e.g., at various times throughout each day, each week, etc.), and new personal health data patterns may be determined based on the additional personal health data on a continuous basis, a periodic basis, or according to any other suitable schedule. As another example, additional personal health data associated with the particular policy holder may be received on a substantially continuous basis, with new premium adjustments being determined for the particular policy holder based on comparisons between the additional personal health data of the particular policy holder and the original or updated personal health data patterns.

In alternative embodiments, the method 300 may include additional blocks not shown in FIG. 3. For example, while the determined insurance premium adjustment in the block 310 may be viewed as an insurance rating, or an indication of loss likelihood, the method 300 may determine a separate insurance rating or loss likelihood indication (e.g., low-risk, medium-risk, high-risk, or a number on a 1-100 scale, etc.), which is then converted to an insurance premium adjustment.

Using the system (e.g., 100) and methods (e.g., 200, 300) described herein, an insurance system may be implemented for providing incentives and insurance ratings based on personal health data received from an insurance policy holder.

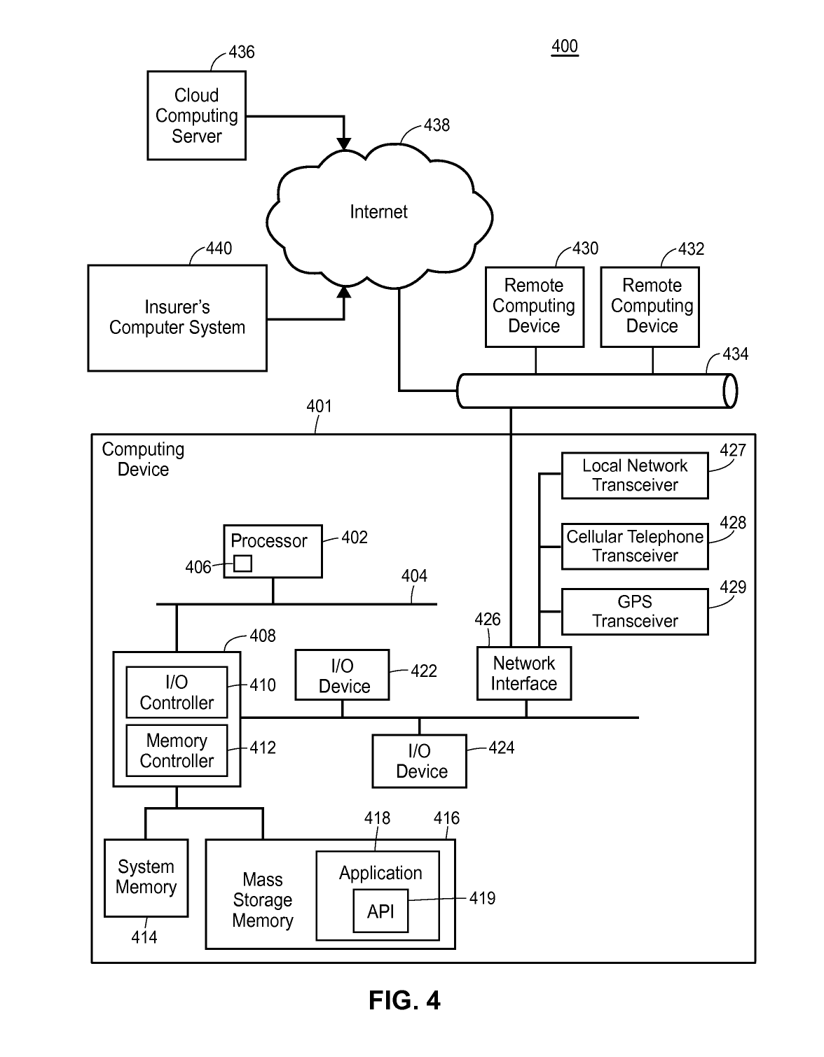

FIG. 4 is a block diagram of an example computing environment for an insurance system 400 having a computing device 401 that may be used to implement the systems and methods described herein. The computing device 401 may include one or more personal health monitoring sensors 104, an insurance server 120, a mobile computing device (e.g., cellular phone, a tablet computer, a Wi-Fi-enabled device or other personal computing device capable of wireless or wired communication), a thin client, or other known type of computing device. As will be recognized by one skilled in the art, in light of the disclosure and teachings herein, other types of computing devices can be used that have different architectures. Processor systems similar or identical to the example insurance system 400 may be used to implement and execute the example system of FIG. 1, the methods of FIG. 2 and FIG. 3, and the like. Although the example insurance system 400 is described below as including a plurality of peripherals, interfaces, chips, memories, etc., one or more of those elements may be omitted from other example processor systems used to implement and execute the example system 100. Also, other components may be added.

As shown in FIG. 4, the computing device 401 includes a processor 402 that is coupled to an interconnection bus 404. The processor 402 includes a register set or register space 406, which is depicted in FIG. 4 as being entirely on-chip, but which could alternatively be located entirely or partially off-chip and directly coupled to the processor 402 via dedicated electrical connections and/or via the interconnection bus 404. The processor 402 may be any suitable processor, processing unit or microprocessor. Although not shown in FIG. 4, the computing device 401 may be a multi-processor device and, thus, may include one or more additional processors that are identical or similar to the processor 402 and that are communicatively coupled to the interconnection bus 404.

The processor 402 of FIG. 4 is coupled to a chipset 408, which includes a memory controller 410 and a peripheral input/output (I/O) controller 412. As is well known, a chipset typically provides I/O and memory management functions as well as a plurality of general purpose and/or special purpose registers, timers, etc. that are accessible or used by one or more processors coupled to the chipset 408. The memory controller 410 performs functions that enable the processor 402 (or processors if there are multiple processors) to access a system memory 414 and a mass storage memory 416, that may include either or both of an in-memory cache (e.g., a cache within the memory 414) or an on-disk cache (e.g., a cache within the mass storage memory 416).

The system memory 414 may include any desired type of volatile and/or non-volatile memory such as, for example, static random access memory (SRAM), dynamic random access memory (DRAM), flash memory, read-only memory (ROM), etc. The mass storage memory 416 may include any desired type of mass storage device. For example, if the computing device 401 is used to implement an application 418 having an API 419 (including functions and instructions as described by the method 200 of FIG. 2 and the method 300 of FIG. 3). The mass storage memory 416 may include a hard disk drive, an optical drive, a tape storage device, a solid-state memory (e.g., a flash memory, a RAM memory, etc.), a magnetic memory (e.g., a hard drive), or any other memory suitable for mass storage. As used herein, the terms module, block, function, operation, procedure, routine, step, and method refer to tangible computer program logic or tangible computer executable instructions that provide the specified functionality to the computing device 401 and the insurance system 400. Thus, a module, block, function, operation, procedure, routine, step, and method can be implemented in hardware, firmware, and/or software. In one embodiment, program modules and routines (e.g., the application 418, the API 419, etc.) are stored in mass storage memory 416, loaded into system memory 414, and executed by a processor 402 or can be provided from computer program products that are stored in tangible computer-readable storage mediums (e.g., RAM, hard disk, optical/magnetic media, etc.).

The peripheral I/O controller 410 performs functions that enable the processor 402 to communicate with peripheral input/output (I/O) devices 422 and 424, a network interface 426, a local network transceiver 427, a cellular network transceiver 428, and a GPS transceiver 429 via the network interface 426. The I/O devices 422 and 424 may be any desired type of I/O device such as, for example, a keyboard, a display (e.g., a liquid crystal display (LCD), a cathode ray tube (CRT) display, etc.), a navigation device (e.g., a mouse, a trackball, a capacitive touch pad, a joystick, etc.), etc. The cellular telephone transceiver 428 may be resident with the local network transceiver 427. The local network transceiver 427 may include support for a Wi-Fi network, Bluetooth, Infrared, or other wireless data transmission protocols. In other embodiments, one element may simultaneously support each of the various wireless protocols employed by the computing device 401. For example, a software-defined radio may be able to support multiple protocols via downloadable instructions. In operation, the computing device 401 may be able to periodically poll for visible wireless network transmitters (both cellular and local network) on a periodic basis. Such polling may be possible even while normal wireless traffic is being supported on the computing device 401. The network interface 426 may be, for example, an Ethernet device, an asynchronous transfer mode (ATM) device, an 802.11 wireless interface device, a DSL modem, a cable modem, a cellular modem, etc., that enables the system 100 to communicate with another computer system having at least the elements described in relation to the system 100.

While the memory controller 412 and the I/O controller 410 are depicted in FIG. 4 as separate functional blocks within the chipset 408, the functions performed by these blocks may be integrated within a single integrated circuit or may be implemented using two or more separate integrated circuits. The insurance system 400 may also implement the application 418 on remote computing devices 430 and 432. The remote computing devices 430 and 432 may communicate with the computing device 401 over an Ethernet link 434. For example, the computing device 401 may receive personal health data created by an application executing on a remote computing device 430, 432. In some embodiments, the application 418 may be retrieved by the computing device 401 from a cloud computing server 436 via the Internet 438. When using the cloud computing server 436, the retrieved application 418 may be programmatically linked with the computing device 401. The application 418 may be a Java® applet executing within a Java® Virtual Machine (JVM) environment resident in the computing device 401 or the remote computing devices 430, 432. The application 418 may also be “plug-ins” adapted to execute in a web-browser located on the computing devices 401, 430, and 432. In some embodiments, the application 418 may communicate with a backend component 440 such as the insurer's computer system 106 via the Internet 438.

The system 400 may include but is not limited to any combination of a LAN, a MAN, a WAN, a mobile, a wired or wireless network, a private network, or a virtual private network. Moreover, while only two remote computing devices 430 and 432 are illustrated in FIG. 4 to simplify and clarify the description, it is understood that any number of client computers are supported and can be in communication within the system 400.

Additionally, certain embodiments are described herein as including logic or a number of components, modules, or mechanisms. Modules may constitute either software modules (e.g., code or instructions embodied on a machine-readable medium or in a transmission signal, wherein the code is executed by a processor) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs)).

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “some embodiments” or “an embodiment” means that a particular element, feature, structure, or characteristic described in connection with the embodiment is included in at least one embodiment. The appearances of the phrase “in some embodiments” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

Further, the figures depict preferred embodiments of a system for providing incentives and insurance ratings based on personal health data from a policy holder for purposes of illustration only. One skilled in the art will readily recognize from the following discussion that alternative embodiments of the structures and methods illustrated herein may be employed without departing from the principles described herein.

Upon reading this disclosure, those of skill in the art will appreciate still additional alternative structural and functional designs for a system and a process for providing incentives and insurance ratings based on personal health data from a policy holder through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

1. A computer-implemented method of encouraging low-loss personal health behaviors, the method comprising:
determining, via one or more processors executing a processor-implemented instruction module, if an individual insurance policy holder has opted to participate in an incentives program;
in response to determining that the individual insurance policy holder has opted to participate in the incentives program, receiving, via the processor-implemented instruction module, baseline personal health data generated by a sensor that measures a baseline personal health condition of the individual insurance policy holder;
based on the received baseline personal health data, receiving, via the processor-implemented instruction module, a target goal set by the individual insurance policy holder to improve or maintain the baseline personal health condition of the individual insurance policy holder over a specified time period;
receiving, via the processor-implemented instruction module, personal health data generated by the sensor that monitors a current personal health condition of the individual insurance policy holder over the specified time period;
in response to having first received the personal health data generated by the sensor, providing, via the processor-implemented instruction module, an indication to the individual insurance policy holder to indicate that an incentive will be directly provided to the individual insurance policy holder;
determining, via the processor-implemented instruction module, if the target goal has been achieved by analyzing the received personal health data and baseline personal health data to determine whether the baseline personal health condition of the individual insurance policy holder has been improved or maintained by the current personal health condition of the individual insurance policy holder over the specified time period; and
in response to determining that the target goal has been achieved, providing, via the processor-implemented instruction module, another indication to the individual insurance policy holder to indicate that a further incentive will be directly provided to the individual insurance policy holder.

2. The computer-implemented method of claim 1, further comprising:
in response to determining that the individual insurance policy holder has not opted to participate in the incentives program, receiving, via the processor-implemented instruction module, personal health data generated by a sensor that monitors a personal health condition of the individual insurance policy holder;
determining, via the processor-implemented instruction module, an indication of loss likelihood for the individual insurance policy holder based on (i) the received personal health data, and (ii) a known correlation between personal health data associated with a plurality of individual insurance policy holders;
determining, via the processor-implemented instruction module, an insurance premium adjustment based on the indication of loss likelihood for the individual insurance policy holder; and
providing, via the processor-implemented instruction module, an indication of the insurance premium adjustment to the individual insurance policy holder.

3. The computer-implemented method of claim 2, wherein determining the indication of loss likelihood for the individual insurance policy holder is based on monitoring the received personal health data to determine a behavior of the individual insurance policy holder.

4. The computer-implemented method of claim 2, further comprising receiving, via the processor-implemented instruction module, additional personal health data generated by an additional sensor that monitors the personal health condition of the individual insurance policy holder, and wherein determining the indication of loss likelihood for the individual insurance policy holder is further based on the received additional personal health data.

5. The computer-implemented method of claim 1, wherein the received personal health data includes data indicating physiological parameters including one or more of a heart rate, a blood pressure, a sleep pattern, or a body weight associated with the individual insurance policy holder collected from a sensor that includes one or more of a heart rate monitor, a blood pressure monitor, a sleep pattern monitor, or a weight scale.

6. The computer-implemented method of claim 1, wherein the received personal health data includes data indicating fitness activities including one or more of walking, running, biking, swimming, or weight training carried out by the individual insurance policy holder collected from a sensor that includes one or more of a pedometer, an electronic fitness bracelet, a smart watch, or a motion sensor.

7. The computer-implemented method of claim 1, wherein the received personal health data includes data indicating one or more time periods during which the sensor was utilized.

8. The computer-implemented method of claim 2, further comprising:
receiving, via the processor-implemented instruction module, the personal health data corresponding to the plurality of individual insurance policy holders and generated by a plurality of sensors that monitors personal health conditions of the plurality of individual insurance policy holders;
wherein the known correlation includes a data pattern corresponding to an increased or decreased probability of incurring a recognizable loss.

9. The computer-implemented method of claim 8, wherein determining the indication of loss likelihood for the individual insurance policy includes determining whether the received personal health data generated by the sensor that monitors the personal health condition of the individual insurance policy holder matches the data pattern; and
wherein determining the insurance premium adjustment for the individual insurance policy holder is based on determining that the received personal health data generated by the sensor matches the data pattern.

10. The computer-implemented method of claim 9, wherein the personal health data corresponding to the plurality of individual insurance policy holders and generated by the plurality of sensors that monitors the personal health conditions of the plurality of individual insurance policy holders includes one or more ranges of sensor output values; and
determining the indication of loss likelihood for the individual insurance policy includes determining whether the received personal health data generated by the sensor that monitors the personal health condition of the individual insurance policy holder falls within a range of the sensor output values.

11. The computer-implemented method of claim 1, wherein the target goal set by the individual insurance policy holder includes lowering a risk associated with the baseline personal health condition of the individual insurance policy holder.

12. The computer-implemented method of claim 1, wherein the target goal set by the individual insurance policy holder includes one or more milestones set during the specified time period of the target goal, and determining if the target goal has been achieved is based on determining if the one or more milestones have been achieved.

13. The computer-implemented method of claim 12, wherein the further incentive is directly provided to the individual insurance policy holder after each of the one or more milestones is achieved.

14. A non-transitory computer-readable storage medium including computer-readable instructions to be executed on one or more processors of a system for encouraging low-loss personal health behaviors, the instructions when executed causing the one or more processors to:
determine, via a processor-implemented instruction module, if an individual insurance policy holder has opted to participate in an incentives program;
in response to determining that the individual insurance policy holder has opted to participate in the incentives program, receive, via the processor-implemented instruction module, baseline personal health data generated by a sensor that measures a baseline personal health condition of the individual insurance policy holder;
based on the received baseline personal health data, receive, via the processor-implemented instruction module, a target goal set by the individual insurance policy holder to improve or maintain the baseline personal health condition of the individual insurance policy holder over a specified time period;
receive, via the processor-implemented instruction module, personal health data generated by the sensor that monitors a current personal health condition of the individual insurance policy holder over the specified time period;
in response to having first received the personal health data generated by the sensor, provide, via the processor-implemented instruction module, an indication to the individual insurance policy holder to indicate that an indication of an incentive will be directly provided to the individual insurance policy holder;
determine, via the processor-implemented instruction module, if the target goal has been achieved by analyzing the received personal health data and baseline personal health data to determine whether the baseline personal health condition of the individual insurance policy holder has been improved or maintained by the current personal health condition of the individual insurance policy holder over the specified time period; and
in response to determining that the target goal has been achieved, provide, via the processor-implemented instruction module, another indication to the individual insurance policy holder to indicate that a further incentive will be directly provided to the individual insurance policy holder.

15. The non-transitory computer-readable storage medium of claim 14, further including instructions that, when executed, cause the one or more processors to:
in response to determining that the individual insurance policy holder has not opted to participate in the incentives program, receive, via the processor-implemented instruction module, personal health data generated by a sensor that monitors a personal health condition of the individual insurance policy holder;
determine, via the processor-implemented instruction module, an indication of loss likelihood for the individual insurance policy holder based on (i) the received personal health data, and (ii) a known correlation between personal health data associated with a plurality of individual insurance policy holders;
determine, via the processor-implemented instruction module, an insurance premium adjustment based on the indication of loss likelihood for the individual insurance policy holder; and
provide, via the processor-implemented instruction module, an indication of the insurance premium adjustment to the individual insurance policy holder.

16. The non-transitory computer-readable storage medium of claim 15, wherein the instructions to determine the indication of loss likelihood for the individual insurance policy include monitoring the received personal health data to determine a behavior of the individual insurance policy holder.

17. The non-transitory computer-readable storage medium of claim 15, further including instructions that, when executed, cause the one or more processors to:
receive, via the processor-implemented instruction module, the personal health data corresponding to the plurality of individual insurance policy holders generated by a plurality of sensors that monitors personal health conditions of the plurality of individual insurance policy holders;
wherein the known correlation includes a data pattern corresponding to an increased or decreased probability of incurring a recognizable loss.

18. The non-transitory computer-readable storage medium of claim 17, wherein the instructions to determine the indication of loss likelihood for the individual insurance policy include determining whether the received personal health data generated by the sensor that monitors the personal health condition of the individual insurance policy holder matches the data pattern; and
wherein instructions to determine the insurance premium adjustment for the individual insurance policy holder include determining the insurance premium adjustment based on determining that the received personal health data generated by the sensor matches the data pattern.

19. A computer system for encouraging low-loss personal health behaviors, the system comprising:
a personal health data repository; and
an insurance server, including a memory having instructions for execution on one or more processors, wherein the instructions, when executed by the one or more processors, cause the insurance server to:
determine, via the one or more processors executing one or more processor-implemented instruction modules, if an individual insurance policy holder has opted to participate in an incentives program;
in response to determining that the individual insurance policy holder has opted to participate in the incentives program, receive, via a network connection, baseline personal health data generated by a sensor that measures a baseline personal health condition of the individual insurance policy holder;
store the received baseline personal health data in the personal health data repository;
based on the received baseline personal health data, receive, via a network connection, a target goal set by the individual insurance policy holder to improve or maintain the baseline personal health condition of the individual insurance policy holder over a specified time period;
receive, via a network connection, personal health data generated by the sensor that monitors a current personal health condition of the individual insurance policy holder over the specified time period;
store the received personal health data in the personal health data repository;
in response to having first received the personal health data generated by the sensor, provide, via the one or more processors executing one or more processor-implemented instruction modules, an indication to the individual insurance policy holder to indicate that an incentive will be directly provided to the individual insurance policy holder;
determine, via the one or more processors executing one or more processor-implemented instruction modules, if the target goal has been achieved by analyzing the received personal health data and baseline personal health data in the personal health data repository to determine whether the baseline personal health condition of the individual insurance policy holder has been improved or maintained by the current personal health condition of the individual insurance policy holder over the specified time period; and
in response to determining that the target goal has been achieved, provide, via the one or more processors executing one or more processor-implemented instruction modules, another indication to the individual insurance policy holder to indicate that a further incentive will be directly provided to the individual insurance policy holder via the network connection.

20. The computer system of claim 19, further comprising:
a correlation data repository; and
wherein the instructions of the insurance server, when executed by the one or more processors, further cause the insurance server to:
in response to determining that the individual insurance policy holder has not opted to participate in the incentives program, receive, via a network connection, personal health data generated by a sensor that monitors a personal health condition of the individual insurance policy holder;
determine, via the one or more processors executing one or more processor-implemented instruction modules, an indication of loss likelihood for the individual insurance policy holder based on (i) the received personal health data, and (ii) a known correlation between personal health data associated with a plurality of individual insurance policy holders stored in the correlation data repository;
determine, via the one or more processors executing one or more processor-implemented instruction modules, an insurance premium adjustment based on the indication of loss likelihood for the individual insurance policy holder; and
provide, via the one or more processors executing one or more processor-implemented instruction module, an indication of the insurance premium adjustment to the individual insurance policy holder.

21. The computer system of claim 20, wherein the instructions of the insurance server, when executed by the one or more processors, further cause the insurance server to:
receive, via a network connection, the personal health data associated with the plurality of individual insurance policy holders, wherein the known correlation includes a data pattern corresponding to an increased or decreased probability of incurring a recognizable loss;
determine, via the one or more processors executing one or more processor-implemented instruction modules, whether the received personal health data generated by the sensor that monitors the personal health condition of the individual insurance policy holder matches the data pattern; and
determine, via the one or more processors executing one or more processor-implemented instruction modules, the insurance premium adjustment for the individual insurance policy holder based on determining that the received personal health data generated by the sensor matches the data pattern.
